(19) United States
(12) Patent Application Publication
(10) Pub. No.: US 2008/0229535 A1
(43) Pub. Date: Sep. 25, 2008

(54) Self tapering finishing knife

(76) Inventor: Thomas Kevin Walter, Alexandria, VA (US)

Correspondence Address: Thomas Walter, 67 Commonwealth Ave., Alexandria, VA, 22301, US

(21) Appl. No.: 11/725,300

(22) Filed: Mar. 19, 2007

(51) Int. Cl. B05C 17/10

(52) U.S. Cl. 15/235.4

(57) ABSTRACT

A tool and method for applying a compound to a surface on which the tapering of the compound is useful for correct finishing. This novel tool and method, when applied to a trade such as drywall finishing, reduces labor time, skill level required, and material consumption to complete the task. The tool and method are generally useful for providing tapered compound and are particularly adapted for the finishing of inside corners, butted seams, and wall hole repairs when tapering of the finishing compound is required.

### FIELD OF INVENTION

The invention relates generally to a tool and a method for spreading and tapering compound, such as joint compound, to finish inside corners of drywall installations. In addition, the tool and method may be used for finishing individual wall hole repairs, and/or butted seams between sections of drywall.

### BACKGROUND OF INVENTION

### 1. Description of Prior Art

The construction trade of drywall finishing requires time consuming practice and a high level of skill to properly finish inside corners, joints, and wall patch repairs. Successful finishing depends on a laborer or homeowner spreading compound at a taper across a taped seam. The taper is achieved by manually holding and moving the finishing tool, most commonly a broad straight edged drywall knife, at the desired taper angle to spread the compound. In addition to being a difficult task for an unskilled laborer or homeowner, manual tapering results in increased application time, inconsistent compound taper thickness, and higher consumption of compound material. An example of a standard finishing practice for a drywall inside corner would be as follows:

Step 1: Using approximately a 4″ flat edged drywall knife, both sides of the approximately right-angled inside corner are coated with a thin layer of joint compound.

Step 2: Paper drywall seam tape is folded at its centerline and pushed into the corner. Excess joint compound beneath the tape is removed by running the same flat edged drywall knife used in Step 1 firmly across the taped seam to squeeze out the buried joint compound.

Step 3: Working one side of the corner at a time to cover the paper drywall tape, the laborer applies, using a wider flat edged drywall knife than used in Step 1 and Step 2, a tapered layer of joint compound, ideally approximately ⅛″ thick at the inside of the corner, tapering to flush with drywall at the opposite side of the flat edged drywall knife. This taper is achieved by manually angling the flat edged drywall knife by holding the knife against the drywall at the flush side and “floating” the knife approximately ⅛″ off the drywall surface at the high side of the taper, which requires a great amount of skill. Once the first side of the corner has dried, the procedure is repeated on the opposite side of the corner.

Step 4: Once both sides have been initially tapered and the compound is dry, the laborer applies, typically two or three, additional coats of joint compound to each side to ensure the paper drywall tape is buried beneath the compound. The additional layers aid in removing thickness inconsistencies in the initial layer applied in Step 3 while building up the taper, but again must be completed by manually tapering the joint compound to achieve a smooth, even, and finished seam.

Specialized tools are known in the prior art mostly for manually tapering with flat blades, finishing both sides of inside corners with double edges, or burying paper drywall tape with elevated rectangular notches, which would not be suited for inside corners or for wall hole repairs.

U.S. Pat. No. 4,620,369 by Gercken represents the standard broad flat edged drywall knife commonly used in construction today. This tool, although potentially effective for a highly trained laborer, requires manual angling to taper compound when finishing a seam. Having to manually angle to achieve a taper generally means longer times for application of compound and may potentially lead to uneven tapering.

U.S. Pat. Application Publication 20020002754 by Wendel presents an alteration of the standard flat edge drywall tool by incorporating a concave edged tool. This tool may be effective for certain applications, but is generally limited to finishing a flat seam where two drywall sheets are butted together. This tool fails to be useful for work on inside corner applications because inside corner application requires compound to be applied in a triangular taper, not a concave taper. Moreover, this tool would also be inefficient in finishing wall hole repairs (if it can be used at all).

U.S. Pat. No. 2,934,936 by Vernon introduces trowels, also commonly used in joint compound application, with various concave radius edges used to effectively cover paper drywall tape and drywall seams. However, similar to U.S. Pat. Application Publication 20020002754 by Wendel above, Vernon's tool can not be used for inside corners, or easily used for wall hole repairs.

U.S. Pat. No. 6,606,758 by Fridman, discloses a tool that is similar in result to Vernon's trowel. The tool disclosed by Fridman utilizes elevated serrated teeth at both ends of the tool blade to create a means for covering paper drywall tape. However, this tool is designed for flat butted seam applications and would not be useful for the triangular compound taper used in inside corner applications. Moreover, it is not particularly suited for wall hole repair.

U.S. Pat. No. 4,217,673 by Pearson alters the standard broad flat drywall knife design with protrusions from the blade sides with the specific function of keeping the knife blade from touching the opposite side in an inside corner application. However, the design of this tool does not aid in producing the compound taper required for finishing a seam or joint.

U.S. Pat. No. 5,467,497 by Greene et al., discloses a tool that is specifically used for an inside corner application. This tool is useful for finishing both sides of an inside corner at the same time. However, this tool does not provide a means for controlling the triangular taper required in spreading a compound material. Moreover, this tool cannot be used for wall hole repairs, or flat butted seam applications.

The above described art, and other known prior art, fail to address the primary issue of providing a means for tapering compound in an inside corner application, as well as additional applications such as tapering used on flat butted seams and wall hole repairs. Therefore, it is the intention of this device to fulfill this requirement, by providing a tool and a method for controlling the thickness of tapered compound for inside corner applications. In addition, the tool and associated methods of the present invention decrease labor application times, reduce material waste, allow for repeatable uniform application of compound, and decrease the skill level required for successful completion of the above described tasks.

### SUMMARY OF THE INVENTION

It is the objective of the present tool and associated methods to provide a novel tool and methods for improving the process of tapering a finishing compound over a seam in an application, such as finishing drywall with joint compound. The tool and method allow the novice, as well as the professional, a means of achieving high quality results by removing the manual tapering requirement of the existing tools and methods. It is also the objective of the present tool and method to reduce material waste, decrease labor time, provide for a repeatable uniform taper, and decrease the skill level required in finishing applications requiring the spreading and tapering of a compound.

### BRIEF DESCRIPTION OF DRAWINGS

FIG. I is a top view of an embodiment of the present invention with detail of protrusion (1.3) on front edge (1.4) of knife blade (1.1).

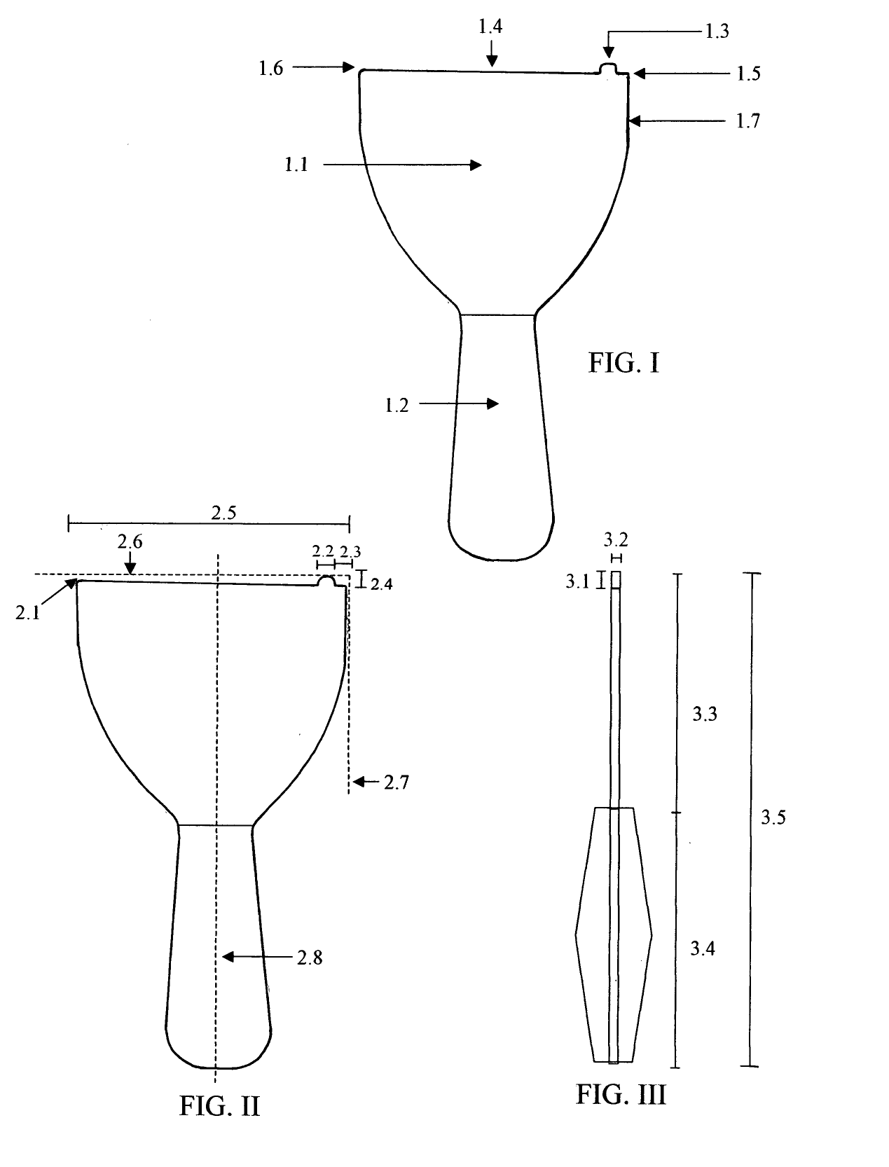

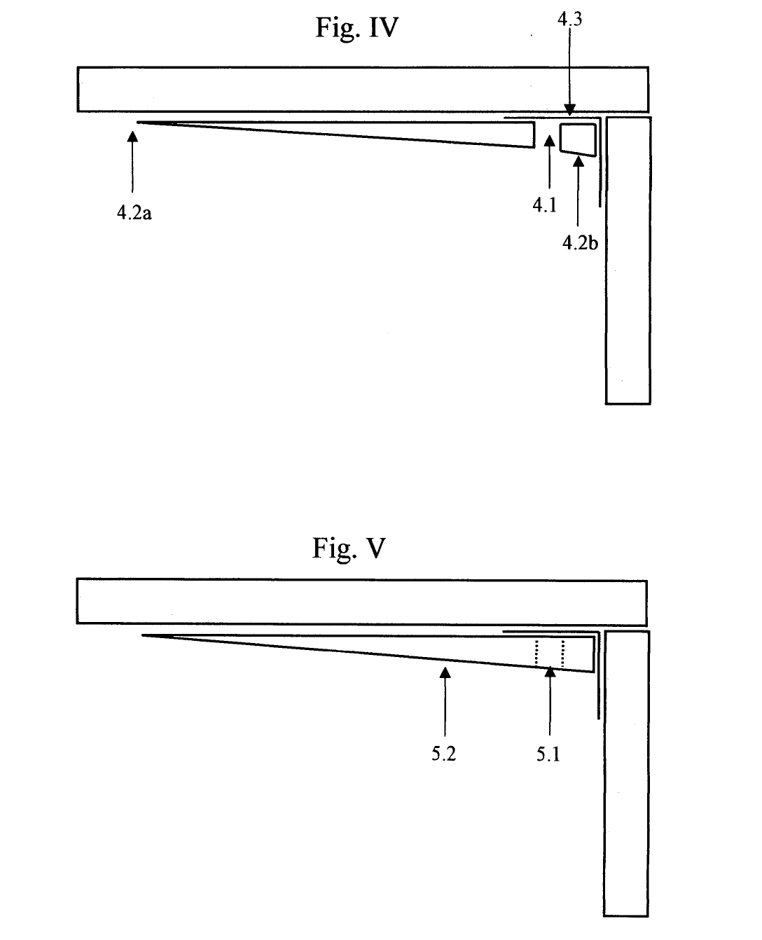

FIG. II is a top view of an embodiment of the present invention with reference lines showing the tapered angle of front edge (1.4 in FIG. 1) with the protrusion (1.3 in FIG. 1).

FIG. III is a side view of present invention.

FIG. IV is a profile view of a typical drywall inside corner after Step 4 (as described in detail below) of an embodiment of the present invention with the associated method of use.

FIG. V is a profile view of a typical drywall inside corner with groove filled in with compound during Step 5 (as described in detail below) of the finishing process with an embodiment of the present tool and associated method.

FIG. VI is a three-dimensional layered perspective view of the typical stages involved in the finishing of an inside corner.

FIGS. VII A-C show a wall hole repair application using a tool embodiment and method of the present invention.

### DETAILED DESCRIPTION OF THE INVENTION

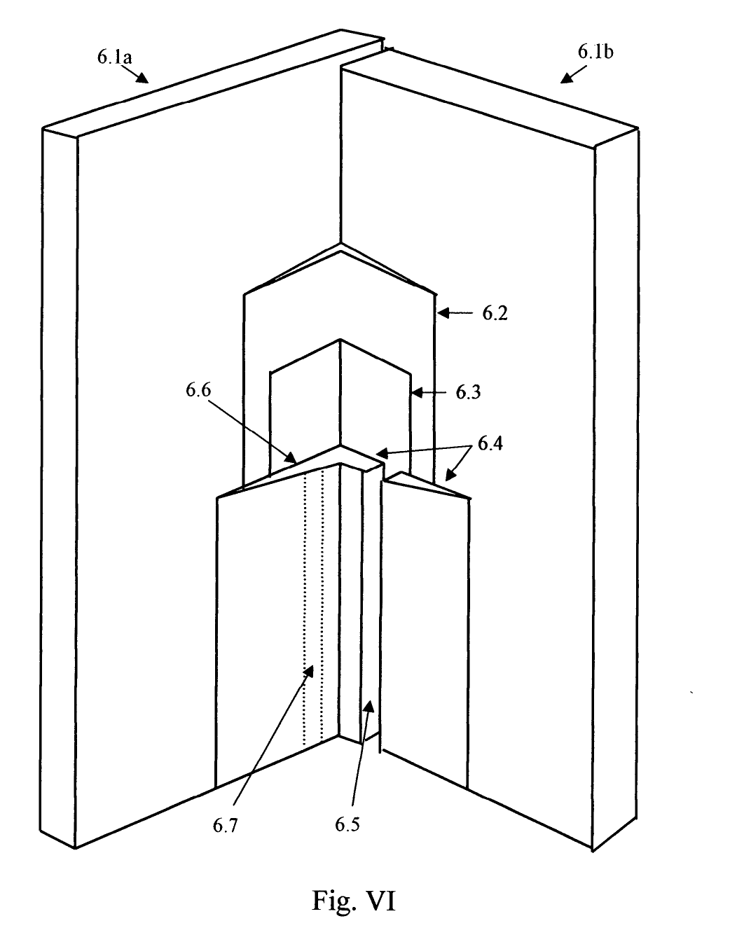

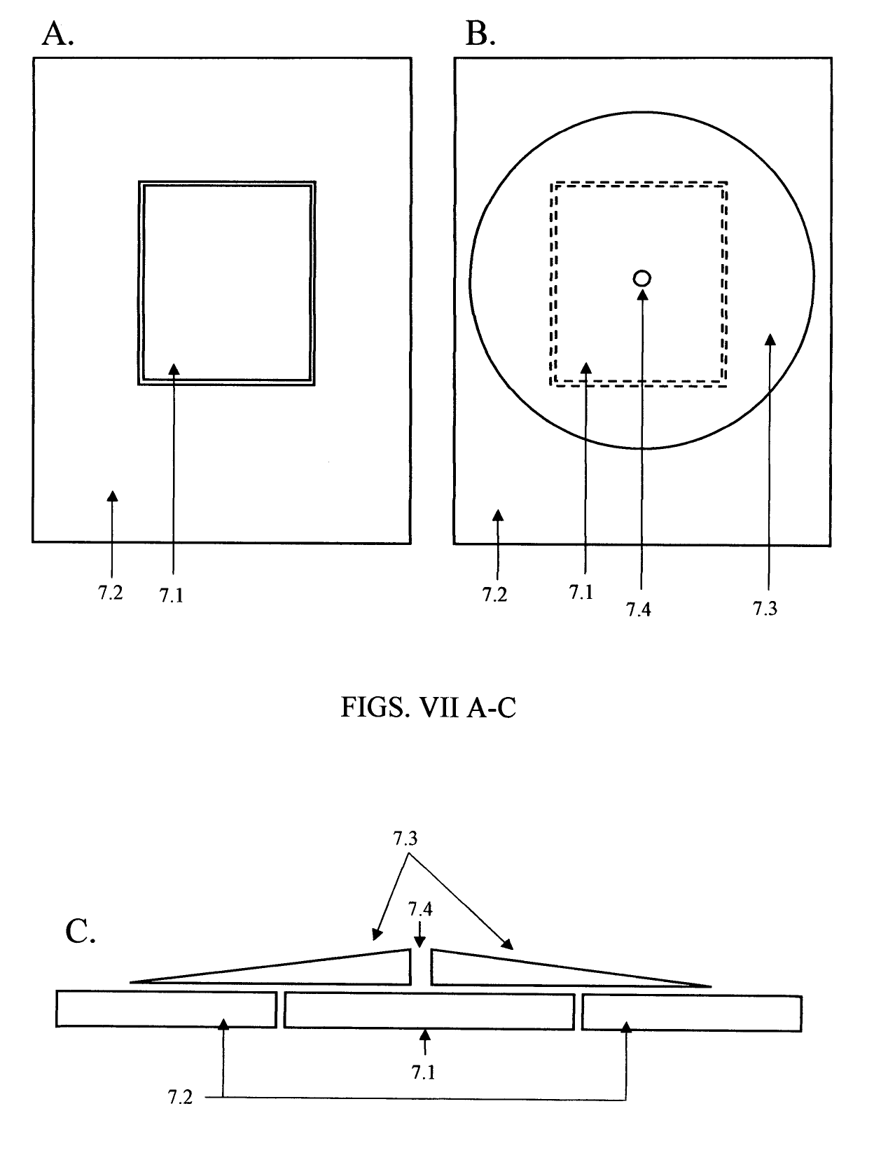

As shown generally in FIG. 1, an embodiment of the present invention is a tool that may be constructed of a broad, flat, semi-flexible blade (1.1) with a handle (1.2) opposite the blade side of the tool. The blade, having various widths (2.5) commonly from 4″ to 12″, and various thicknesses (3.2) commonly ⅛″ or less, is constructed of a sturdy and semi-flexible material, such as plastic or metal. If plastic or metal is used, the plastic should be sufficiently rigid to spread light to heavy weight compound, yet flexible enough so that it has some give. In other words, the blade should be capable of spreading light to heavy weight compounds, such as drywall joint compounds, putties, or other spreadable compounds. If metal is used, the metal may be stainless steel so that rust is not a problem. The blade edge (1.4) is designed at an angle, demonstrated by the right-angle created at the intersection of drawn lines (2.6 and 2.7) as shown in FIG. 2 in relation to blade corners (1.5 and 1.6) and blade edge (1.4), with a ¼″ wide (2.2) by ¼″ tall (2.4) protrusion (1.3) located slightly inset (2.3) from one corner of the blade (1.5). By ‘slightly inset from one corner’ it is meant that if the blade edge (1.4) is divided into segments that are thirds of equal length, the protrusion (1.3) is entirely present in a region that is in the first third segment from one corner. The size and location of protrusion (1.3) may vary per design. It should be recognized that the protrusion height may be any of a variety of sizes depending on the taper that one is trying to achieve. Moreover, the width of the protrusion (2.2) can vary. In an embodiment, the protrusion (1.3) is generally located at a position similar to that shown in FIGS. I or II but may be moved to be useful in proportion to the overall tool size embodiment. It should be recognized that if a line or plane is drawn (2.8) so that it perfectly bisects the handle in the lengthwise direction (i.e., equal amounts of handle are present on each side of the plane), the blade edge (1.4) is close to but not perpendicular to this line or plane. However, a second line (2.6) that is drawn from one corner (1.6) of the blade edge (1.4) to the top of the protrusion (1.3) is substantially perpendicular to the line or plane (2.8) that bisects the handle. It should also be recognized that an embodiment of the present invention may be a tool wherein blade edge (1.4) is perpendicular to a line or plane (2.8) that bisects the handle, with the top edge of protrusion (1.3) in relation to corner (1.6) creating the taper necessary as described in the method of use for the present invention.

The handle (1.2) may be a single molded piece incorporating the blade, or a separate affixed piece, or comprised of multiple pieces, constructed of a material, such as plastic, hard rubber, ceramic, metal, wood, or some other appropriate material. In an embodiment, the handle is narrower than the blade edge (1.4) and shaped with eased corners and edges, with suitable thickness for the comfortable and functional grip in the hand of the user. Tool blade height (3.3), protrusion height (3.1), handle height (3.4), and overall tool height may vary, with overall tool height (3.5) commonly ranging from 7″ to 12″, although it should be appreciated that other sizes may be used.

FIG. VI shows an exemplary embodiment of a method in which this tool may be utilized. This exemplary method is explained with reference to the current standard process for finishing a drywall inside corner. STEP 1: Both sides of the corner are coated with a thin layer of joint compound (6.2) using a standard broad flat edged drywall knife (such as can be done with the tool in U.S. Pat. No. 4,620,369 by Gercken). STEP 2: Paper drywall tape (6.3) is folded along its creased center seam, then pushed into the corner, with folded center seam of paper drywall tape aligning with the inside corner formed by the butted drywall sheets (6.1a and 6.1b) adhering to wet joint compound applied in step-one. STEP 3: Using a standard broad flat edged drywall knife, the paper drywall tape (6.3) is embedded into the underlying joint compound (6.2) by firmly pushing the paper drywall tape (6.3) into compound (6.2) with the flat blade edge while sliding drywall knife along one side of the seam at a time until excess joint compound has been sufficiently removed from both sides of inside corner and paper drywall tape (6.3) is securely embedded and adhered to the drywall sheets (6.1a and 6.1b). STEP 4: Using a standard broad flat edged drywall knife, a thin layer of joint compound is again applied to one side of inside corner to cover paper drywall tape. Then, using one of the tool embodiments of the present invention (i.e., a Self Tapering Finishing Knife), with side edge (1.7) placed toward inside of drywall corner, while simultaneously pressing tool corner (1.6) and protrusion (1.3) against drywall (6.1b), holding knife edge (1.7) at approximate 45-degree angle to drywall (6.1b), the tool is moved along the inside corner seam removing excess joint compound while leaving remaining compound tapered (6.4), and creating groove (6.5) from the tool protrusion (1.3). The resulting taper is approximately ⅛″ at its high side tapering to completely flush with drywall surface at the taper's low side resulting from the angled taper derived from the taper in the tool from the high side (2.4) to the low side (2.1). A profile view of the result of step-four is shown in FIG. IV with the taper of approximately ⅛″ at inside of corner (4.2b) tapering per design of tool to flush (4.2a) with the drywall at opposite side, leaving a groove vacant of compound (4.1), while covering paper drywall tape (4.3) with the compound. The user may also apply the compound in this step directly to the wall surface using one of the tool embodiments of the present invention, by loading the face (1.1) of the tool with compound and spreading compound directly on the wall surface as described above, therefore eliminating the need to use a standard broad flat edged drywall tool in this step to pre-apply the compound to the surface. STEP 5: Once the compound dries, the corner is coated with a thin layer of joint compound using a standard broad edged drywall knife, then using the edge of the same drywall knife, the wet compound is spread along the corner, allowing the dried tapered compound beneath to act as a guide to the blade, with the knife blade bridging the groove (6.5). Moving the drywall knife along the corner seam allows for the removal of excess joint compound while leaving the groove (6.5) filled with joint compound (6.7), resulting in a tapered compound (6.6) covering one side of inside corner. A profile view of the result of step-five is shown in FIG. V, with the groove filled (5.1) and resulting tapered application of joint compound (5.2). STEP 6: Once dry, optionally a final coat can be applied if necessary using a flat blade drywall knife to the same side to fill and smooth any imperfections in the surface. STEP 7: The process is repeated for the opposite side of corner. STEP 8: As a final step, one may optionally lightly sand to finish.

The tools and methods of the present invention may also be used to apply tapered finishing to butted seams, as well as to repair wall holes. The process for both of these procedures are similar to the inside corner application, in that a layer of compound is applied using a flat broad edged drywall knife, then excess compound is removed using one exemplary tool of the present invention (such as the Self Tapering Finishing Knife) to create compound taper over seams. When used in wall hole repair, after a typical wall patch (7.1) is applied to wall (7.2) with a hole, the entire repair area is covered with joint compound (not shown in Figure). The Self Tapering Finishing tool is placed so that the protrusion (1.3) touches the drywall in the center of the repair area and the corner (1.6) of the tool is outside the repair area. The user rotates the tool 360 degrees around repair as if drawing a circle with a compass, which results in a tapered circle (7.3) surrounding the repair area, with a center groove (7.4) where the protrusion (1.3) on the tool was placed. Once the tapered circle of compound dries, the center groove (7.4) is filled with compound to complete the repair.

The tapering knife and associated methods have been described in connection with the above described embodiments. It should be recognized that the invention is not to be limited by the above described embodiments, but rather the invention encompasses variations that one of skill in the art would recognize are within the spirit and scope of the present invention. In this regard, it should be recognized that any disclosed feature of the present invention can be combined with any other disclosed feature of the invention and still remain within the scope of the present invention. Similarly, in the methods described above, it should be recognized that the method steps may be optionally left out or included, or the method steps may be performed in a different order, all of which are within the spirit and scope of the present invention. Finally, the invention is not to be limited by the above description but rather is defined by the below claims.

I claim:

1. A tool comprising a handle and a blade, the handle operationally connected to the blade, and the blade having a blade edge with a protrusion emanating from a location at or inset from one corner of the blade edge wherein the blade edge is almost but not quite perpendicular to a line that perfectly bisects a length of the handle.

2. The tool of claim 1, wherein the protrusion is about ¼″ wide by ¼″ tall.

3. The tool of claim 1, wherein the blade edge is between 4 and 12 inches in length.

4. The tool of claim 2, wherein the blade edge is between 4 and 12 inches in length.

5. The tool of claim 1, wherein the tool has a height of about 7 to 12 inches.

6. The tool of claim 1, wherein the handle is made of one or more members selected from the group consisting of wood, metal, plastic, hard rubber and ceramic.

7. The tool of claim 1, wherein the blade is directly connected to the handle.

8. The tool of claim 1, wherein the blade is made of one or more members selected from the group consisting of plastic and metal.

9. The tool of claim 8, wherein the blade is metal and the metal is stainless steel.

10. A method of spreading and tapering joint compound at an inside corner, butted seam, or wall hole repair, the method comprising:
applying joint compound using a tool that comprises a handle and a blade, the handle directly connected to the blade, the blade having a blade edge with a protrusion emanating from the blade edge, wherein the blade edge is close to but not perpendicular to a line that perfectly bisects a length of the handle.

11. The method of claim 10, further comprising allowing the joint compound to dry.

12. The method of claim 11, further comprising filling in a groove that results from the spreading and tapering joint compound with additional joint compound to generate a completed tapered joint compound.

13. The method of claim 12, further comprising allowing the additional joint compound to dry.

14. The method of claim 13, further comprising sanding the completed tapered joint compound.

15. The method of claim 14, wherein the blade edge is between about 4 and 12 inches in length.

16. The method of claim 15, wherein the tool has a height of between about 7 and 12 inches.

17. The method of claim 10 wherein the tool is rotated in a 360° fashion to generate a tapered circle that has the joint compound thicker at a location close to the circle center and thinner at the circle edge.

18. The method of claim 17, further comprising allowing the tapered circle to dry and filling in a hole at the circle center with additional joint compound.

19. The method of claim 18, further comprising sanding the tapered circle.

20. A tool comprising a handle and a blade, the handle operationally connected to the blade, and the blade having a blade edge with a protrusion emanating from a location at or inset from one corner of the blade edge, wherein a line drawn from the tip of the protrusion to a corner of the blade edge is not perpendicular to a line that perfectly bisects a length of the handle.
